(19) United States
(12) Patent Application Publication
(10) Pub. No.: US 2018/0340626 A1
(43) Pub. Date: Nov. 29, 2018

(54) Pilot Assisted Self-Powered Actuator Valve and Device

(71) Applicant: Mingsheng Liu, Omaha, NE (US)

(72) Inventor: Mingsheng Liu, Omaha, NE (US)

(21) Appl. No.: 15/607,656

(22) Filed: May 29, 2017

(51) Int. Cl. F16K 31/40; F16K 31/10; F16K 31/126; F16K 31/385

(52) U.S. Cl. CPC F16K 31/404; F16K 31/105; F16K 31/0606; F16K 31/385; F16K 31/402; F16K 31/1264

(57) ABSTRACT

A pilot assisted self-powered valve actuator for vertical action valves (global valve, gate valves, and others), rotation action valves (ball valves, butterfly valves, and other plug valves), and four-way modulation valves to control flow from 0% to 100%. It consists of actuator chamber which is connected to both valve inlet and outlet, an actuator plug which is positioned by one or two coil springs and is driven under the pressure difference from inlet and outlet of the valve, and a pilot valve and bleeding hole(s) which control and adjust the pressure on one side of the actuator plug. The pilot assisted self-powered valve provides superior control performance and costs a fraction of the pneumatic and/or electrical control actuators.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relates to control valves for process control where pressure, differential pressure, flow, temperature, and other parameters need to be controlled at the desired value or level. These valves include but are not limited to global valve, gate valve, ball valve, butterfly valve, and four-way modulation valve.

### DESCRIPTION OF THE RELATED ART

A control valve is a valve used to control fluid flow by varying the size of the flow passage as directed by a signal from a controller. This enables the direct control of flow rate and the consequential control of process quantities such as pressure, temperature, and liquid level. The valve movement is driven by its actuator, which may use high pressure gas as power, electrical as power, and liquid to be controlled.

When the high pressure gas is used as power, the actuator is called pneumatic actuator, which is capable to deliver high torque, quick movement, and safe to the toxic and inflammable environment. However, air compressor system (air compressor and compressed air distributing pipelines) is required to produce the compressed air. In the last 30 years, pneumatic control valves and/or actuators are gradually phased out in commercial applications although it is still used in some of the industrial process.

When electrical power is used as the power, the actuator is called electrical actuator. Electrical actuator is widely used for today's flow control. The valve requires special power voltage. Special power wire has to be installed. For large valves, the actuators cost are very high.

When the valve's move is controlled by the fluid to be controlled, the actuators are called self-powered since no external power is required. Self-powered actuator or valves have been existed for long time. However, its functions are limited to constant pressure control, constant differential pressure control, constant flow control, constant over-heat control, constant water level control, and others.

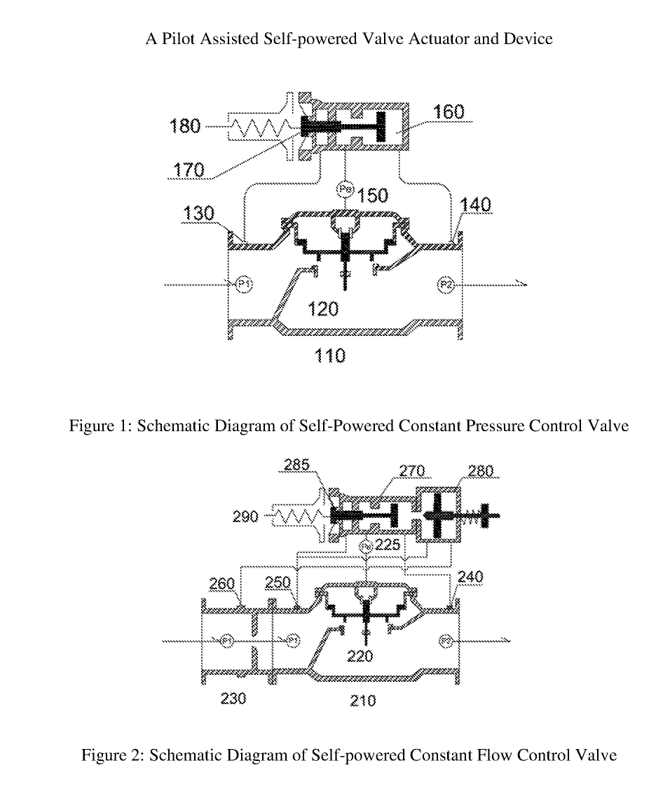

FIG. 1 presents the schematic diagram of self-powered constant pressure control valve and actuator. The actuator consists of valve chamber 160, valve plug 170, coil spring 180, supply port 130, discharge port 140, and acting port 150. When both valve supply and discharge port are connected to the actuator ports, the actuator maintains constant pressure drop of the valve. The valve ports can be moved to inlet and outlet of any controlled subject. Then, the actuator will be able to control the pressure drop across the controlled subject constant. If the supply port is disconnected, the actuator will be able to control constant discharge pressure. If the discharge pressure is disconnected, the actuator will be able to vary the flow to maintain the supply pressure to a reasonable level. If one of the ports is disconnected and the other port is relocated to another location of the water/liquid loop, the actuator will be able to maintain the constant pressure at the port location. Many mechanical structures have to be developed to perform the same task. It should be pointed out that the self-powered actuator is normally very close to the controlled subject since the piping and maintenance of the piping between the valve and the controlled subject can be an issue if the distance is long.

FIG. 2 presents the schematic diagram of self-powered constant flow control valve and actuator. The actuator consists of two coil springs (290, 295), two plugs (280, 285), four ports (260-orifice port, 250-inlet port, 240-discharge port, and 225-action port). An orifice 230 is added to the valve. The flow rate must be pre-adjusted manually on site in order to change flow requirement. Upon the adjustment is performed, the single flow rate is delivered. Many other mechanical structures have been developed to control the constant flow.

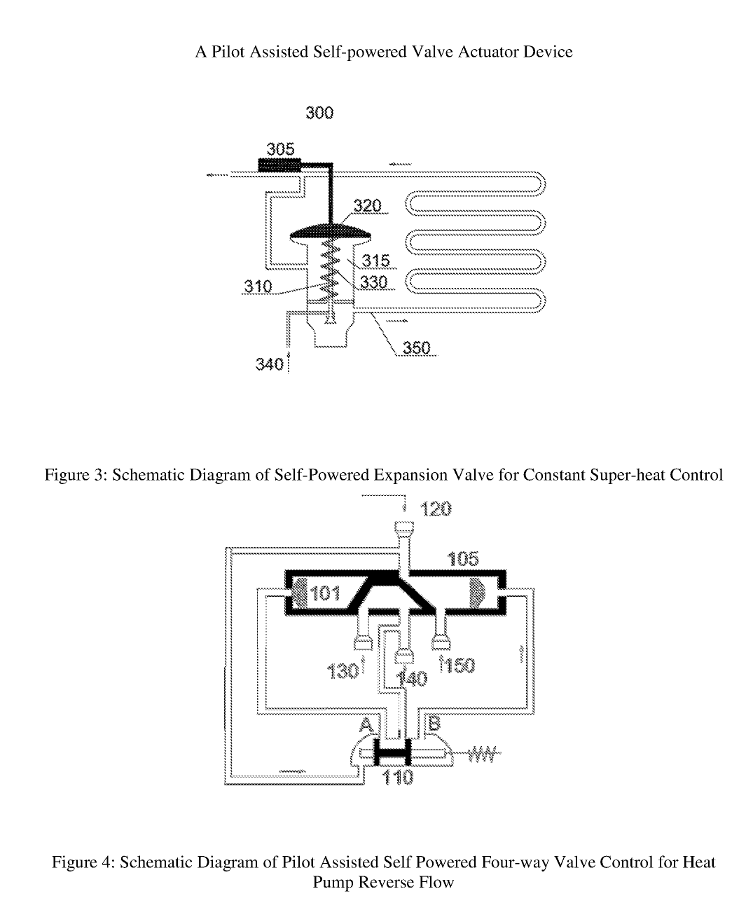

FIG. 3 presents the commonly used expansion valve control in air conditioner. The actuator consists of pressure chamber 310, diaphragm 320, spring coil 330, evaporator pressure port, liquid port 340, and evaporator 350. The saturated pressure coincident to the superheated vapor is acting on the top of diaphragm. The evaporator pressure is acted on the other side of the diaphragm. The coil spring is adjusted to set up the degree of super heat. The superheat is higher than the designed valve, the valve is pushed down to reduce refrigerant flow and vice versa. The self-powered actuator maintains constant degree of superheat.

FIG. 4 presents the commonly used reverse valve and actuator. It consists of four-way pilot valve (410), cylindrical plug (405), valve chamber (420), compressor port (430), suction port (440), outdoor port (450), and indoor port (460). The four-way pilot valve (410) can connect the compressor pressure to the right side of the valve chamber 420, and the suction pressure to the left side of the valve chamber 420. Under the pressure difference on the left and right sides, the cylindrical plug (405) is pushed to the left. Then, the hot and high pressure gas is guided to the indoor unit for heating. If the four-way pilot valve (410) connects the compressor high pressure to the left side and suction pressure to the right side of the valve chamber (420), the cylindrical plug (405) is pushed to the right side. The control valve sends the hot and high pressure gas to the outdoor units. This is not entirely self-powered since a four-way pilot valve is used. And the pilot valve is electrical powered. This is called pilot assisted self-powered control valve. This demonstrates a good example of two position control.

As illustrated above, many self-powered control valves and actuators are developed. However, all of them are restricted to a single constant parameter control, such as constant pressure, constant temperature, and constant flow. In modern control industry, the control targets are often optimized or changed. For example, the supply air static pressure for air handling units should be reset based on the building load. The minimum set point can be as low as 30% of the maximum set point. The single constant control target limited the use of the self-powered actuator and valves in todays' control industry. In addition to the limited applications, the mechanical structures are very complex. The installations are difficult to perform as well. For pneumatic and electrical actuators, the cost of control actuators and associated electrical and pneumatic systems are high.

In order to extend self-powered actuators to modern control industry applications and reduce the cost of the existing pneumatic and electrical actuator, a pilot assisted self-powered valve actuator is described in this application. The proposed embodiment differs from the prior art in that the pilot assisted self-powered actuator and device modulates liquid/gas flow through the valve from 0% to 100% to satisfy any process control need, and the pilot assisted self-powered actuator and device fits all type of valves: four-way modulation valve, two-way rotation action valve (ball valves, butterfly valves), and vertical action valves (gate valve, global valve). This novel pilot assisted self-powered actuator and device has a variety of advantages over the prior art as discussed below.

The proposed embodiment is self-powered with simpler structure and maintenance free.

The proposed embodiment reduces actuator cost and has no supporting facility need comparing to pneumatic and electrical actuators.

The proposed embodiment has the same control performance of modern electrical and costly pneumatic control actuator performance, and is applicable to any type of valves and any type of control process.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In an embodiment, a pilot assisted self-powered actuator and device for vertical action valves (gate valve, global valve) is provided. It consists of a cylindrical actuator chamber, coil spring and adjustor, disk plug with a track rod, a connection port on the top of the actuator chamber, a connection port on the bottom of the actuator chamber, at least two track bars, and a pilot two-way control valve on one of the connection port tube.

In an embodiment, a pilot assisted self-powered actuator device for rotation action valves is provided. It consists of a actuator chamber, a plate plug, two coil springs and adjustors, a track rod, a connection port on the left of the actuator chamber, a connection port on the right of the chamber, and a pilot two-way control valve on one of the connection port tube.

In an embodiment, a pilot assisted self-powered actuator device for four-way modulation valves is provided. It consists of a actuator chamber, a plate plug, two coil springs and adjustors, a track rod, a connection port on the left of the actuator chamber, a connection port on the right of the chamber, and a four-way pilot control valve.

The above-described summary, features, and advantages of the present disclosure thus improve upon aspects of those systems and methods in the prior art designed to control the valves for liquid, water, and compressed air and gas.

### DRAWINGS REFERENCE NUMERALS

100 Schematic Diagram of Prior Art Self-powered Constant Pressure Control Valve and Actuators
110 Valve chamber
120 Valve plug
130 Inlet port
140 Discharge port
150 Valve stamp
160 Actuator chamber
170 Actuator plug
180 Coil spring
200 Schematic Diagram of Prior Art Constant Flow Self-Powered Control Valve
210 Valve chamber
220 Valve plug
225 Actuator shaft
230 Orifice
240 Outlet port
250 Inlet port
260 Orifice port
275 Actuator plug 1
280 Actuator plug 2
285 Actuator chamber
290 Coil spring
295 Coil spring
300 Schematic Diagram of Prior Art Self-powered Expansion Valve and Actuator
305 Superheat thermal bulb
310 Superheat gas chamber
315 Evaporator gas chamber
320 Diaphragm
330 Coil spring
335 Valve plug
340 Liquid port
350 Evaporator port
400 Schematic Diagram of Prior Art Heat Pump Reverse Valve and Actuator Principal
405 Cylindrical plug
410 Four-way pilot valve
420 Valve chamber
430 Compressor port
440 Suction port
450 Outdoor unit port
460 Indoor unit port
500 Pilot Assisted Self-Powered Valve Actuator for Vertical Action Valves
505 Cylindrical actuator chamber
510 Coil spring and adjusting screw
520 Actuator plug
530 Track rod (at least 2)
535 Bleeding hole
540 Bottom port
550 Top port
560 Pilot control valve
580 Valve plug
600 Pilot Assisted Self-Powered Valve Actuator for Rotation Action Valves
610 Actuator chamber
620 Actuator plug
630 Track rod
640 Coil spring
650 Bleeding hole
660 Pressure port 1
665 Pilot valve
670 Pressure port 2
680 Valve plug
700 Pilot Assisted Self-Powered Valve Actuator for Four-way Modulation Valves
710 Actuator chamber
720 Actuator plug
730 Track rod
740 Coil spring
750 Bleeding hole
760 Pressure port 1
770 Pressure port 2
780 Four-way pilot modulation valve
785 Inlet port
787 Outlet port
790 Valve plug

### BRIEF DESCRIPTION OF THE DRAWINGS

It will be appreciated that for simplicity and clarity of illustration, elements illustrated in the following figures have not necessarily been drawn to scale. For example, the dimensions of some of the elements are exaggerated relative to other elements for clarity. Advantages, features and characteristics of the present disclosure, as well as methods, operation and functions of related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is the schematic diagram of prior art self-powered constant pressure valve example.

FIG. 2 is the schematic diagram of prior art self-powered constant flow valve diagram.

FIG. 3 is the schematic diagram of prior art self-powered thermal expansion valve for air conditioning system application.

FIG. 4 is the schematic diagram of prior art pilot assisted reverse valve heat pump application.

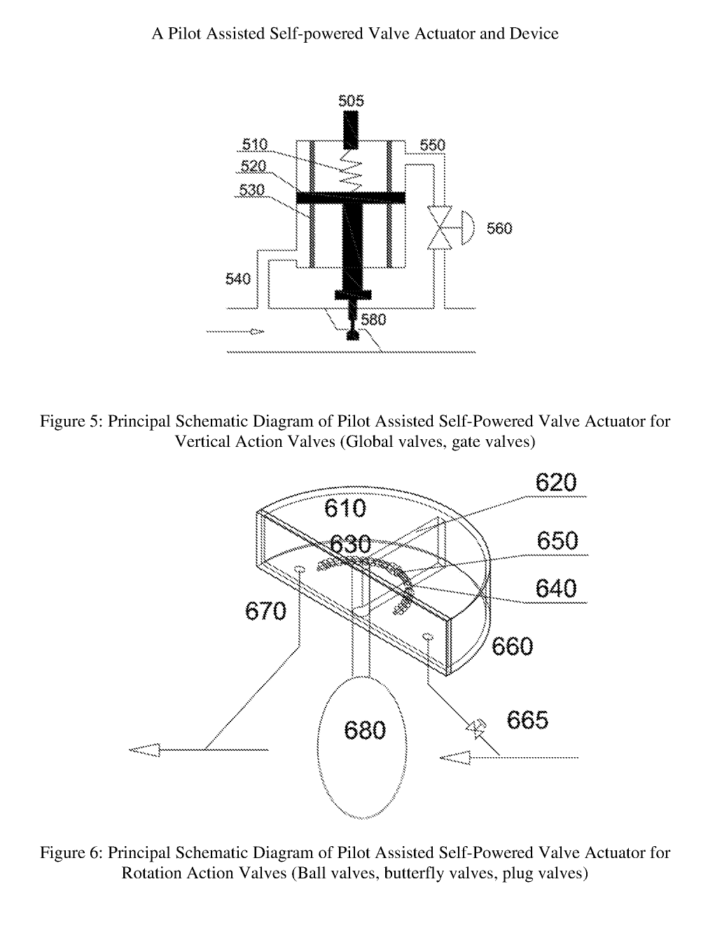

FIG. 5 is the principal diagram of pilot assisted self-powered actuator for vertical action valves.

FIG. 6 is the principal diagram of pilot assisted self-powered actuator for rotation action valves.

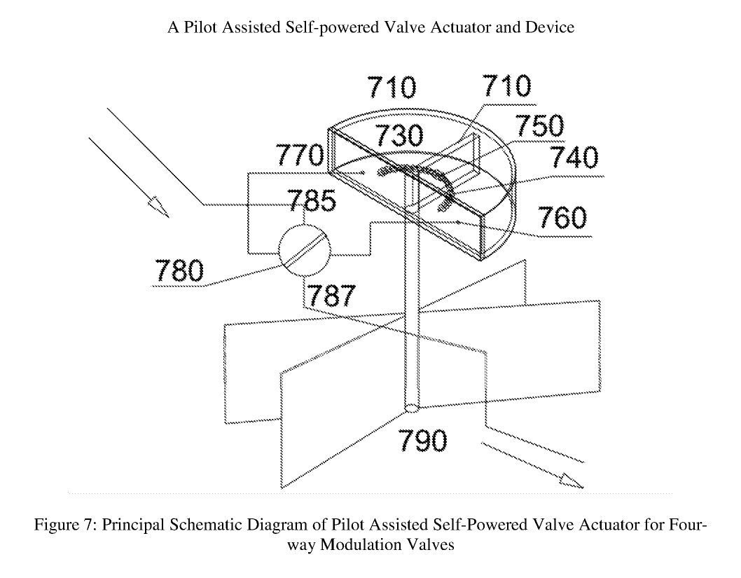

FIG. 7 is the principal diagram of pilot assisted self-powered actuator for the four-way modulation valves.

### DETAILED DESCRIPTION

Before the present methods, systems, and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. Nothing herein is to be construed as an admission that the embodiments described herein are not entitled to antedate such disclosure by virtue of prior invention.

Pilot assisted self-powered valve actuator 500 for vertical action valves is illustrated in FIG. 5. Pilot assisted self-powered valve actuator for vertical valves can be implemented to gate valves, global valves, and any valves with vertical movement of valve plugs. In the embodiment illustrated in FIG. 5, 580 is the valve plug, which moves vertically to adjust the flow to satisfy the control need. 505 is a cylindrical actuator chamber, which may be in other than circular shape. 510 is a coil spring, which can be installed on either top or the underneath the actuator plug disk 520. Two coil springs may be installed on either side of the actuator plug disk separately. The actuator plug 520 moves along the cylindrical actuator chamber 505. The actuator plug 520 shall have a good contact and have a limited fluid leakage from top to bottom or from bottom to the top. 530 is the track rod of the actuator plug 520. Track rod 530 shall ensure the actuator plug 520 is leveled properly. 535 is the bleeding hole, which is also the intersection of the actuator plug 520 and track rode 530. 540 is the bottom port, which can be connected to either inlet or outlet of the valve. 550 is the top port, which can be connected to either inlet or outlet of the valve. However, bottom and top ports shall be connected to different positions of the valve (inlet or outlet). 560 is the pilot valve.

The pilot assisted self-powered valve actuator for vertical action valves 500 works with valves which have preloaded spring for either normally open or closed device. It also works with valves which don't have the loaded spring for the pre-position valves. In fact, it can convert these valves to either normally open or normally closed valves. This can potentially reduce the valve structure and cost.

As illustrated in FIG. 5, the valve inlet is connected to the bottom port 540. The outlet of the valve is connected to the top port 550. When a compressed coil spring 510 is used, the valve is normally open. When a stretched coil spring 510 is used, the valve is normally closed. Let assume that a compressed coil spring is used, the pilot valve is closed. The cylindrical chamber 505 has the uniform pressure since top and bottom are connected through the bleeding holes 520. Under force of the coil spring 510, the valve plug 580 is pushed down. The valve is full open. Under control demand, the pilot valve 560 can be modulated to any position from fully closed to fully open. In order to close the valve, the pilot valve 560 is opened more. More high pressure water flows to the bottom of the actuator disk plug 520. Bottom pressure is higher than the pressure on the top of the actuator plug 520. The actuator plug 520 is pushed upward. Then, the valve plug 580 is pushed up ward. The valve is closed more. The valve position is determined by the sum of the forces of coil spring, pressures under and above the actuator plug 520. By modulating the pilot valve 560 position, the pressure above the disk plug can be effectively changed. Therefore, the valve plug 580 can be controlled to any desired position and modulate the flow from 0% to 100% of the design flow.

FIG. 600 presents the schematic diagram of pilot assisted self-powered valve actuators for rotation action valves, which can be butterfly valves, ball valves, and any valves which modulate the flow by rotating the valve plug. 610 is the actuator chamber. 620 is the actuator plug, which rotates circling the valve shaft under the combined forces of coil spring, and pressures on the left and right sides. 630 is the track rod, which stabilize the actuator plug 620 and also keep the bleeding hole clean. 640 is the coil spring. The coil spring 640 provides stability of the actuator plug 620, and position the actuator plug 620 in the center of the actuator chamber 610. To enhance the stability, two spring coils may be installed on each side of the actuator plug 620. 650 is the bleeding hole, which have the track rod passing through. The bleeding hole allows fluid flow from the high pressure side to the low pressure side. 670 is the left port. 660 is the right port. Each port can connected to either the inlet or outlet of the valve. However, they can't be installed on the same side. 665 is the pilot valve. Pilot valve 665 can position the valve from 0% open to 100% open. 680 is the valve plug, which can be either butterfly plug, ball plug, and/or any other plug which modulate flow by rotation.

As illustrated in FIG. 600, the left port 670 is connected to the outlet of the valve. The right port 660 is connected to the inlet of the valve. The actuator plug 620 is fastened to the valve shaft when the valve plug 680 is fully closed. To fully open the valve plug 680, pilot valve 665 opens up. The pressure on the right side of the actuator plug 620 is built up. The actuator plug 620 is pushed to rotate toward left. To modulate the valve position from 0% to 100%, just modulate the pilot valve 665 position to change pressure on the right side of the actuator plug 620.

FIG. 700 presents the schematic diagram of pilot assisted self-powered valve actuators for four-way modulation valves. The four-way modulation can reverse the flow, block the flow or isolate the primary and the secondary systems, and modulate the flow. 710 is the actuator chamber. 720 is the actuator plug, which rotates circling the valve shaft under the combined force of coil spring, and pressures on the left and right sides of the actuator plug. 730 is the track rod, which stabilizes the actuator plug 720 and also keeps the bleeding hole clean. 740 is coil the spring. The coil spring 740 provides stability of the actuator plug 720, and position the actuator plug 720 in the center of the actuator chamber 710. To enhance the stability, two spring coils may be installed on each side of the actuator plug 720. 750 is the bleeding hole, which have the track rod passing through. The bleeding hole allows fluid flow from the high pressure side to the low pressure side. 770 is the left port. 760 is the right port. 780 is the pilot four-way modulation valve. 785 is the inlet port, and connected to the inlet of the valve. 787 is the outlet port, and connected to the outlet port. In fact, the inlet port 785 connection is interchangeable with the outlet port 787. 790 is the four-way modulation valve plug.

As illustrated in FIG. 700, the inlet port 785 is connected to the inlet of the valve. The outlet port 787 is connected to the outlet of the valve. To isolate or block the system, put the pilot four-way modulation position to block port 785 and 787. The actuator plug 720 is positioned in the center of the actuator chamber 710. The four-way valve plug seal the flow from the primary supply to the valve chamber, and also seal the flow from valve chamber to the return. For normal flow, connect the inlet port 785 to left port 770. To modulate the flow, modulate the pilot valve position within 35 degree range from the left to change the flow to the actuator chamber. To reverse the flow, connect the inlet port 785 to the right port 760. To modulate the flow, modulate the pilot valve position within 35 degree range from the right.

It will be apparent to those skilled in the art that various modifications can be made in the system for optimizing the pilot assisted self-powered valve actuators from the scope or spirit of the given embodiment. Other embodiments will be apparent to those skilled in the art from consideration of the specification and practice of the disclosure in this application.

What is claimed is:

1. A pilot assisted self-powered valve actuator and method for modulating the valve flow from 0% to 100% to satisfy dynamic control purpose, said self-powered actuator for a valve comprising:
at least one actuator plug which either moves vertically or rotates to the control the valve position.
at least one coil spring which pre-positions the valve and provide stability of the actuator plug.
at least two ports which are located at the valve inlet and outlet respectively.
at least one actuator chamber which hosts the actuator plug and is connected to the inlet and the outlet of the valve.
at least two pipelines which connect the actuator chamber to both inlet and outlet ports.
at least one pilot valve which can be installed on either the pipeline which connects the inlet port and the actuator chamber or the pipeline which connects the outlet port to the actuator chamber.
at least one bleeding hole which adjust the pressure on one side of the actuator plug.
at least one track rod.

2. The self-powered actuator of claim 1, wherein said valve is a global valve.

3. The self-powered actuator of claim 1, wherein said valve is a gate valve.

4. The self-powered actuator of claim 1, wherein said valve is a ball valve.

5. The self-powered actuator of claim 1, wherein said valve is a butterfly valve.

6. The self-powered actuator of claim 1, wherein said valve is a four-way modulation valve.

7. The self-powered actuator of claim 1, wherein said pilot valve is a global valve.

8. The self-powered actuator of claim 1, wherein said pilot valve is a ball valve.

9. The self-powered actuator of claim 1, wherein said pilot valve is a gate valve.

10. The self-powered actuator of claim 1, wherein said pilot valve is a butterfly valve.

11. The self-powered actuator of claim 1, wherein said pilot valve is a four-way modulation valve.

12. The self-powered actuator of claim 1, wherein said pilot valve can be installed on either the pipeline which connects the inlet port and the actuator chamber or the pipeline which connects the outlet port to the actuator chamber.

13. The self-powered actuator of claim 2, wherein said the coil spring preset the actuator plug and valve at a normal open position, or a normal closed position.

14. The self-powered actuator of claim 3, wherein said the pressure port can be connected to either inlet or outlet of the control valve.

15. The self-powered actuator of claim 3, wherein said the pressure port can be connected to either a supply pipe or a return pipe where both the supply and the return pipes are close to each other.

16. The self-powered actuator of claim 4, wherein said the pilot valve can be installed on either pressure port section.

17. The self-powered actuator of claim 5, wherein said pleading hole cross section must be smaller than the either inlet or outlet cross section.

18. The self-powered actuator of claim 6, wherein said the inlet and outlet port may have the same or different diameter(s).

19. The self-powered actuator of claim 7, wherein said the actuator plug moves vertically for global and gate valves and rotates for butterfly valves, ball valves, and four-way modulation valves.

20. The self-powered actuator of claim 8, wherein said four-way modulation valve have the following function: reverse the flow, block the flow, and modulate the flow from 0% to 100%.

21. The self-powered valve actuator of claim 9, wherein said pilot assisted self-powered valve actuator for rotation action valve rotates the actuator plug a minimum 90 degree angle.

22. The self-powered valve actuator of claim 10, wherein said pilot assisted self-powered valve actuator for four-way modulation valve rotates actuator plug at least 135 degree angle.
